(19) United States
(12) Patent Application Publication
(10) Pub. No.: US 2008/0027895 A1
(43) Pub. Date: Jan. 31, 2008

(54) System for searching, collecting and organizing data elements from electronic documents

(76) Inventor: Jean-Christophe Combaz, Paris (FR)

Correspondence Address: ST. ONGE STEWARD JOHNSTON & REENS, LLC, 986 BEDFORD STREET, STAMFORD, CT, 06905-5619, US

(21) Appl. No.: 11/494,927

(22) Filed: Jul. 28, 2006

(51) Int. Cl. G06F 17/30

(52) U.S. Cl. 707/1

(57) ABSTRACT

A system for automatically or manually collecting data from electronic documents that comprises a combination of functionalities which include in particular a one-click automation system to navigate through the electronic documents, a query system to locate data through other systems on the network—if present—which may have already performed similar searches, filtered views of the electronic documents or pages, an automatic structure recognition system and a multi-purpose collection basket, which is a user database accepting polymorphic data. The collected data is stored into the user's basket either by a manual drag and drop or automatically, as the user—or the program—navigates from document to document or page to page. If the collected data includes links to other documents, these associated documents can be automatically downloaded by the system and saved to storage devices.

### FIELD OF THE INVENTION

This invention relates to extraction and collection of data from heterogeneous information sources, and in particular from data accessible via the World Wide Web. More particularly, the present invention relates to applications, on computer systems or other online devices, including Internet browsers, semantic browsers, data scrapers for database systems or media and news syndication systems. Amongst the embodiments of this invention is a system allowing to create in a very limited number of clicks or keystrokes, an automatic agent which will collect desired elements of information on the Internet, structure the collected data and export it to allow its use in most common office or personal applications.

### BACKGROUND OF THE INVENTION

While, in terms of number of users, the growth of the Internet has now slowed dramatically in most industrialized countries, the number of queries performed in the main search engines is increasing at a very significant rate. This phenomenon denotes a clear change in the users behavior, which rely more and more massively on the Web for their information needs—both personal and professional. The wide availability of data on the Internet encourages users to perform ambitious researches, but the information overload makes these searches long and difficult.

If finding a specific piece of information is relatively easy using available tools and search engines, getting large collections of data like professional contacts, images, web site addresses, email addresses, ads or news on a specific subject require a large amount of time and repetitive manual operations. In order to constitute a database of sales leads, for example, or in a job search process, the users will go through numerous Web sites, browse through the pages, visually recognize the type of information they are looking for, copy it and paste it in other applications, or save the pages in order to manually edit the data and give it, for instance, a structure that can be accommodated in a database or a spreadsheet. There are systems and tools allowing the extraction of specific types of data from the Web or other large sources of information but, as there is no all-purpose standardized data format and navigation system, the way they proceed is usually by allowing the user to record sequences of actions in scripts and replay the scripts to perform recurring searches. The available tools therefore require necessary preliminary steps of tedious configuration and scripting in order to perform a search. Additionally, as these systems rely on the most common formats available, namely HTML and XML to recognize the data structure, rough and non-structured data will most often be ignored.

The present invention is a system offering a much simpler way to collect data, by including intelligent recognition systems that will dispense the non-specialist from these preliminary setup and scripting tasks, therefore allowing users with no computer and programming skills to perform complex and deep searches in a few clicks, keystrokes or vocal commands. This invention offers in particular answers to five of the most crucial expectations of the non-specialist:
a one-click automation system, to browse through the sources,
one-click filters to view directly the type of data they are looking for within the pages,
an easy-to-use, non-volatile, multi-purpose repository to collect and prioritize the data they find while surfing, whatever its structure is,
an automatic system to check on their own machine and amongst their peers if a similar query was not performed recently, in order to reuse successful extraction processes—or results themselves, if they haven't changed,
an easy way to structure and export their collections for other applications.

### SUMMARY OF THE INVENTION

The purpose of the invention is primarily to search and extract collections of data elements of one or several type(s), organize these collections into structured and reusable tables and, if needed, add to them semantic annotations, in the form of meta-data, to define their elements or describe relations between them. Many of the functionalities offered by the invention can be automated with a single click or command, without having to pre-record a succession of tasks or program a script. This allows both manual and automated scraping of data or media elements for Internet users without specific skills or training.

Amongst the possible embodiments of the invention on various devices and for various applications, one provides a simple system for non-specialist Internet users to manually collect data on the Internet or make their computer explore multiple sources and automatically collect data meeting certain search criteria.

### BRIEF DESCRIPTION OF THE DRAWINGS

FIG. 1 is a functional overview of the invention. In the pages and documents visited, the invention recognizes navigation elements and links and uses them to automatically explore the other documents and pages of the series they belong to. The invention then recognizes the data structure, applies filters and allows to collect the data elements found into the collection basket, while information about the source and its data structure are stored into the Web Memory.

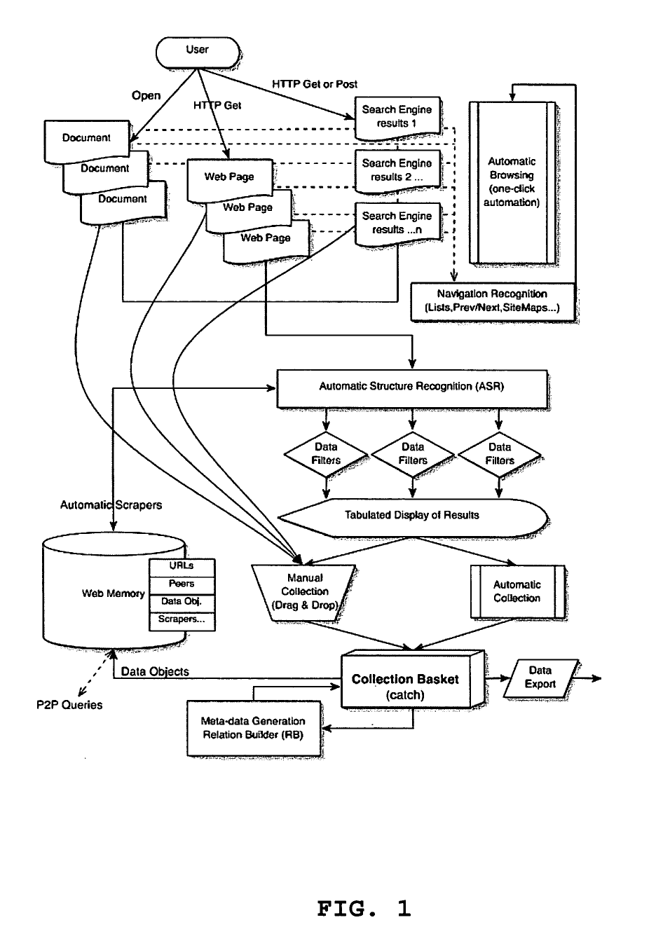

FIG. 2 is an Automatic Structure Recognition (ASR) the document is scanned for recurring patterns. Frequencies of the found patterns are used to determine the most plausible masks to scrape the document's data. After a number of iterations, the best results are displayed.

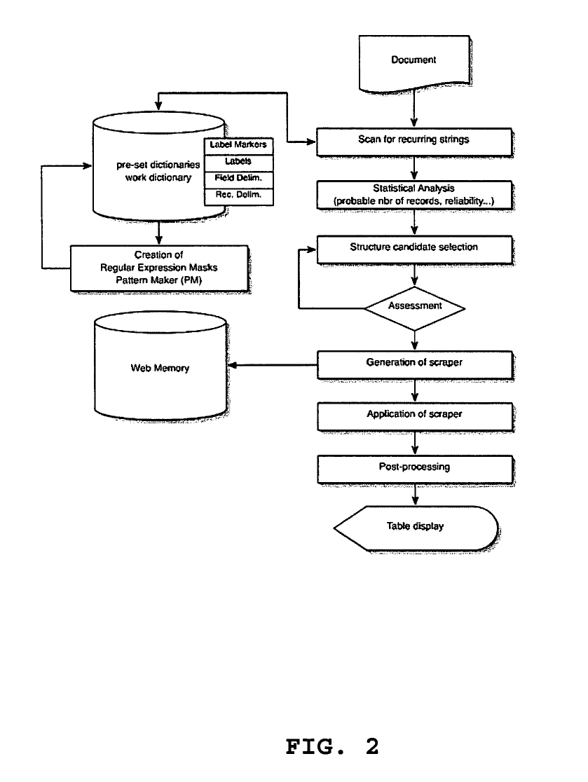

FIG. 3 is a Relation Builder (RB) on a polygon or ellipse around an object, or on the edges of the selection highlight color, appear “hot spots” from which can be drawn relations to other objects. The conventional relative positions of the hot spots allow the program to limit the number of possible semantic relations and propose the most likely to the user.

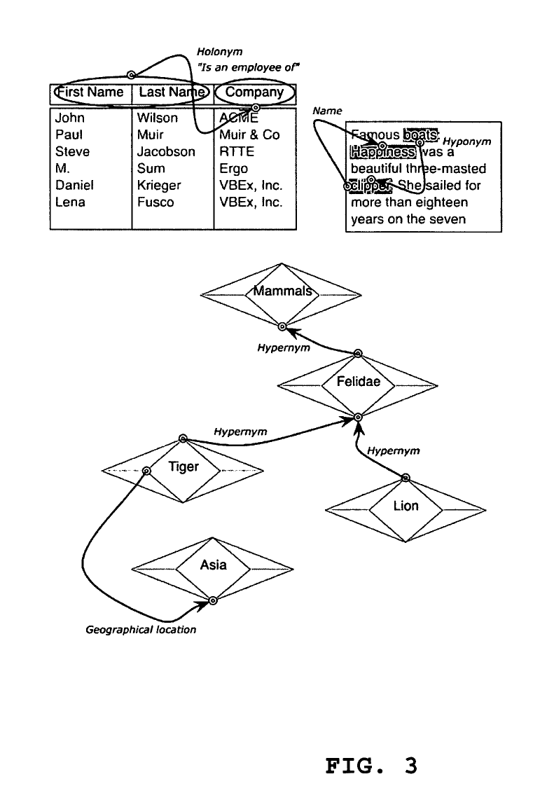

### DETAILED DESCRIPTION OF THE INVENTION

In this embodiment of the invention, the user is provided with a zone covering the largest portion of the screen, the Page Panel, where are displayed the current data source and/or the different filtered views of the data source. Each filtered view is accessible via a tab, a menu item or any other type of user command. The user can see the rendered page (HTML page, PDF file, image, text document . . . ) or, by selecting any of the other views, only display all data elements of a certain type (URL links, email addresses, images, RSS feeds, people contacts, etc.), that are contained in the current document or page. In the rendered page as in the filtered views, the displayed data is dynamic and the links are active so the users can browse from source to source, remaining in whatever view they prefer.

The first view of the Page Panel, the Page view, is the HTML browser itself, rendering the current document or page in the same way as Microsoft Internet Explorer, Mozilla, Safari, FireFox or other common Internet browsers do. In order to remain compatible with the evolution of online technologies, the present embodiment of the invention uses the API, libraries and plug-ins of the most common browsers on each platform for rendering the pages and documents. (In other embodiments, the invention can itself be implemented as a plug-in or extension of common browsers). Over the rendered page is an optional layer, colorizing zones of the page or sections of text, displaying for instance meta-data, annotations or semantic links that are present in the page or document or associated to it, according to the preferences of the user.

The second view (Image/Media view) is a list of the graphic, video or audio elements of the document or page. The list is presented in a table with, for each item, a series of fields, describing the element (file name, title/caption/alternate text, size, colors . . . ). A thumbnail visualization or representation of each item is created when the view is opened, while the items are saved in temporary files in a multi-threaded way.

An unlimited series of other views (Links, Emails, Contacts, News . . . views) display, in a table, data of the selected type that is found in the current source page, with, for each item, relevant fields to describe the data elements. In each of these views, the users are given a plurality of additional sorting and filtering tools to refine their searches. Thus, in the News view, for instance (which displays a table of all the RSS articles found in the feeds the current page links to), they can type a simple search string or a regular expression to highlight all the elements containing the string or matching the expression. Once highlighted these elements can easily be saved to the Catch basket either by dragging them to it or simply by pressing the Return key. A checkbox allows the user to ask the system to move automatically the selected elements to the Catch, as soon as a new page or document is loaded. Finally, these elements of the list (or the files and documents they link to) can also be saved directly to the hard disk.

Two special views, named the Lists and Detail views do not simply mechanically recognize a type of data elements to list, but call the Automatic Structure Recognition module (ASR) to try and infer from the recurrence of certain patterns, the underlying structure of the data presented in the current page. These two views will respectively present the page as a list or table with one record per row, or as the detailed layout of a single record where all fields are presented integrally on the page. Unlike the previous views, which present elements of a single type, the List and Detail views can present the data in rows and columns without recognizing its nature, but only its structure. The following steps of the process are to recognize the nature of the fields and to try inferring semantic relations between them. These are done as post-processing tasks.

In addition to the Page Panel, the interface includes the address field where the user can type a query or an URL, all common navigation buttons for browsing the Internet, and additional navigation buttons (Next in Series, Browse, Dig, Site Home, Contacts . . . ).

Finally, all data collected can be added to a Collection Basket, where the user of the invention can store various types of data elements or records, and the associated Detail View of the currently selected item.

Functional Description of the Main Modules and Interface Elements:

Automatic Structure Recognition (ASR)

This module scans the content of a text file, an HTML page or other electronic documents, to identify recurring or remarkable patterns and, in a succession of iterations, makes assumptions on possible label markers, field delimiters, record delimiters and deducts a possible data structure (typically in records and fields or in hierarchical lists), then assesses each structure candidate by computing a reliability ratio and finally presents the data as a table, using the structure with the highest reliability ranking (and allowing the user, if the result is not satisfying, to show the second best, etc.). The structure recognition process includes 5 main steps:

1. work dictionary: Constitution of a work dictionary of marker candidates for different types of markers (label markers, labels, field delimiters, record delimiters, list markers, etc.) using all available tags (XML, HTML . . . ), punctuation or layout description strings. An original dictionary of pre-set marker candidates is augmented of strings recurring frequently in the document as well as of characters or strings consistently located, in the current document, between easily recognizable patterns like phone numbers or email addresses.

2. statistical analysis: the markers of the dictionary are combined to generate regular expression patterns and the number of occurrences of each pattern is added to arrays on which are then performed a series of statistical computations to extract possible numbers of records in the document and reliability marks are given to the different solutions.

3. automatic scraper generation: the result of this analysis is a series of regular expressions (or masks) that are selected as the best way to scrape the data in the document. This automatically generated set of scraping patterns is saved for future use (by the user or an other peer on the network, which could have the same need for scraping this source) and associated to the URL of the current HTML page or document.

4. scraper application: Data is then extracted from the current page by applying the generate scraper, and is presented in a table where the recognized records are displayed as rows, the fields as the columns and the labels—if present—are used as column headings. Applying the scraper consists of parsing the document record by record and field by field (or item by item, in the case of a single column list), using the delimiters and masks of the scraper. If several fields of the same record have the same label, they will be presented in two columns with the same heading (possibly suffixed with an incremented index).

5. post-processing: once all the data is placed in rows and columns, the whole table is processed again, cell by cell, to clean the text of possible noise, de-duplicate redundant data, arrange the layout, optimize column sizes, etc.

One-Click Automation

This system includes three modules: the Navigation Recognition Module, the Auto-Browsing Module and the Scripting Engine, as well as a number of interface elements. The Navigation Recognition module uses very versatile, multi-lingual scrapers to recognize useful navigation links present in the current page or document and—if time allows it—calls the site map finder method. The navigation links found activate the corresponding navigation buttons and commands present in the user interface, which include the Next in Series Button/Command (to go to the next page in a series of result pages—in a database query result, for instance, or a search in Google or Yahoo), the Browse Button/Command (to automatically go through all the pages in a series of results), the Dig Button/Command (to go through all the pages in a series of results, recursively visiting the pages they link to, down to a set level of depth), the Site Home Button/Command (linking to the home page of the current Web page or the top of the current document), the Contact Info Button/Command (linking to the contact page of the current Web site or—if a contact page is not found- a section of the current document containing a list of people names and contacts), etc.

The Auto-Browsing module, also used in scripting operations requiring automatic exploration, is a loop that performs a number of operations for each URL to be visited. It manages and cleans all views, variables and history data, gets the next URL to open, validates it, automates the loading, according to the type of document it refers to, waits for the loading completion, performs preliminary checks and recognition tasks on the page or document, makes some corrective decisions in case of errors, checks if a scraper exists for this URL in the user's database and waits for a given temporization period before looping to the next URL.

The automatic exploration tools given to the user actually generate automation scripts (or agents, when they are combined with filters to grab data), without requiring any preliminary stage of configuration or programming. The scripts generated by clicking on the navigation buttons are “One-Bearing” scripts, which means that they contain one set of configuration instructions and filters to grab data, one starting URL, a maximum number of iterations and a maximum depth. The Script Engine will execute this type of scripts as a loop until the maximum number of iterations has been reached or until there is no more link to follow.

One-Bearing scripts can still involve some level of automatic navigation and routing as the helm is given to the Auto-Browsing Module, which is able to make basic decisions (including for instance, back tracking, in case of dead end).

One-Bearing script are expressed by the invention as a URL, starting with the prefix “outwit://” and including the start URL and additional parameters that will be interpreted by the Script Engine to set the program configuration. These outwit URLs generated by the invention can easily be copied by the user and pasted (into an email, for instance) to share an interesting search, slideshow etc.

As One-Bearing scripts can be produced automatically and as the Script Engine can execute them, it is of course possible for advanced users to produce complex scripts with multiple waypoints, and conditional routes. A script editor allows the production of these scripts in advanced mode.

Collection Basket (Catch)

The Catch is a non-volatile multi-purpose storage system for information elements of different kinds: media elements, text clippings, links, emails, table records . . . It is displayed or hidden at will and it is destined to receive all objects collected by the user while browsing the Internet or any series of electronic documents. As the Catch contains heterogeneous data coming from the different filtered views of the source pages visited, each row of data can be of a different nature and have a different structure.

If all cells of a column are of the same nature (i.e. contain the same field) then the label appears in the column heading, else, labels are concatenated as a prefix to the content of the cell, between the marker characters “#” and “:”. Thus, for instance, if, mixed in a same column of the Catch are first names, last names and phone numbers, they will respectively be marked like this: “#LastName:Wilson”, “#FirstName:John” or “#Phone:1-123-4567”, and the column heading will be empty. Reversely, if all the cells of a column are first names, the column heading will be set to “First Name” and the cell will only contain “John”, “Mike”, etc.

The cell labels can be, in some cases, extracted from the source, together with the data itself or, in other cases, generated by the application. Items of the different views can be dragged into the catch manually, moved by simply pressing the Return key, or moved automatically to the Catch by the application itself, if criteria are entered in the selection filters of the views.

When exported to other applications (like a spreadsheet), using a specific format like Microsoft Excel or a standard transfer format like XML, the data is exported together with its structure at the larger granularity possible. If needed, rows and column can be reordered, so that the data have the largest possible chunks of data with a common structure.

Pattern Finder (PF)

The Pattern Finder module is used in several parts of the invention, in particular in the List Management Tools, to identify a common structure in a collection of character strings, in the form of a regular expression. If the Automatic Structure Recognition (ASR) is used to find a structure within a text or a body of data, the Pattern Finder tries to find a common structure between several elements of data, at the character level. It is used to “clean” the result tables, allowing, for example to filter out heterogeneous elements when a larger part of the collection is of the same nature, or to segment each cell of a column into sub-elements and, this way restructure the extracted data into several more meaningful columns. For instance, if a column contains these four cells: “ph:1-345-5555; fax:1-123/6666”, “phone:1-555 4545; fax:1-234-1234”, “Michael” and “Tel:1-345-5555; fax:1-222 333”, the module will be able to determine that “Michael” is not of the same type, that the other three cells have a common pattern corresponding to the regular expression “[a-z]+:1\-\d\d\d.\d\d\d\d; fax:1-\d\d\d.\d+” and finally that for all cells that share this same format, the “;” character—because it is between two chunks of variable data—may be a good position where to segment the data and subdivide the column into two different columns. The computed regular expression itself remains internal, but transparently allows very useful list management functionalities. This module is, for instance, the one allowing commands and menu items like “Select Similar”, “Select Different” or “Divide Column”, which give the user unprecedented control to manually edit, clean and restructure the collected data before exporting it to other applications.

Object Class Module & Service (OC)

According to the embodiment of the present invention, this module can exist both as a method in a client application and as a Web Service on a server application. Object Class returns, for each query sent to it with a character string and optional context information, the most probable classes of which that string is an instance (“Sofia” would return, according to the context, City, Female First Name, “1-212-3454567” would return Phone Number, “jsmith@site.com” would return Email Address . . . ) A version of the Object Class Module compiled within a client application is necessarily less complete and knowledgeable than a Web Service version of it, and, if the user of the invention has a valid access to the Web Service version, it will be used to complement the knowledge available in the user's client application.

Relation Builder (RB)

An original graphic metaphor is used in the user interface to describe the semantic value of an element of information. It allows to build and to visualize a complex set of relations between the object and its environment. According to the user preferences, the Relation Builder shows, around a selected item, word or phrase, a two dimensional frame (polygon or ellipse) or an interactively animated three-dimensional shape (polyhedron). Some vertices of the shape are meaningful “hot spots” that can be linked to the hot spots of other items. The position of these meaningful hot spots is fixed by convention and represent, for the selected object, the anchors of one or several of the main semantic relations this object can have with its environment (i.e. Top: parents—holonyms, hypernyms; Bottom: children, products—hyponyms, meronyms, causal relations; Sides: siblings, attributes—synonyms, locations, qualifiers . . . ). When the user is dragging a new relation from one of the hot spots of an object to another, the system proposes the most pertinent types of relation between the objects according to the position of the selected anchors. This allows the user of the invention to add semantic annotations to the data and collections (or visualize existing semantic relations if the source document already contains semantic meta-data, in RDF format for instance).

Object Maker (OM)

The Object Maker module allows to create and edit information objects destined to be stored in the Web Memory of the system and possibly shared on the Web or on a peer-to-peer network. The user is provided with a toolbox to create a new class (or subclass inheriting properties of a parent class) describe it and modify it. The system insures that no duplicate classes are created in the accessible area (the local system, resources of a centralized server and/or the peers of the network, if the system is connected to one). A growing number of parent classes and properties is available to the user who can build the object by dragging them into the object editor or by entering them on the keyboard from least specific to most specific, finally entering values for the properties. As the system is meant to be shared between a large number of users, if it is essential that the objects should not have duplicates, it is also necessary that the system should allow an unlimited number of values for each property. It is the system's job to deal with these multiple values by doing automatic statistical analyses of their range, dispersion, average, etc. For example, if a user wants to create an object for the population of Germany, the process will be to create an instance of the object “population” (which is a preset subclass of the object “figure”) where the territory property is set to “Germany” and give the desired value to the property “Value”. Obviously, the property “Time”, in this case will be set by default to the current date and time. The next user (or automatic process) that will need to set a value for the population of Germany will be able to add a value (even different) to the same instance, for the same date and time. A better addressing system is available for creating objects, using the 4D location property. Internally, this Space/Time addressing invokes a specific data format named “4D Cloud” describing a location as a series of numerical coordinates forming vector shapes, and statistical dispersion models, used as textures, describing the distribution of probability densities within the shapes. This addressing system allows a representation at any scale of 4D locations more or less complex, like “North-West Pillar of the Eiffel Tower on Jul. 23rd, 2007 at 2 pm”, “Paris in spring”, or “West Germany in the 60s”. The content of the territory property in our example would be a reference to the 4D Cloud of the territory named “Germany”, at the present time.

Using these tools, the whole community of users on a network can build a knowledge base composed of unique (but open) data objects to which they can add values, attributes and behaviors, using simple and intuitive editing tools, and without fearing redundancy.

Web Memory and <<While-U-Surf>> Indexing (WUSI)

While other tools used to explore the Web or electronic documents remain mostly idle during the time it takes the user to read or view the documents, the present invention is constantly working (using multi-threaded processes) on analyzing the current document, to recognize, understand or infer as much information as possible in it. If meta-data is present, it will obviously be read in priority, the vocabulary of the page will be analyzed as well as its relative semantic position towards other pages of the web site or document, keywords will be extracted, one or several relevant thematic fields will be selected, etc. This semantic information will be compiled and added to the user's Web Memory, using the URL as unique ID. Each time the user grabs data from this URL and when a scraper is created (automatically or manually) and used on this URL, the scraping information will also be saved and linked to the URL. Statistics on the user's behavior (number of visits, time spent . . . ) will also be linked to the URL, allowing to infer information on the user and his/her fields of interest and expertise. Lastly, all Data Objects created by the user are saved in his/her Web Memory and possibly replicated in other systems of the network. The Web Memory thus rapidly becomes a very valuable resource for the user. It is naturally reserved for the personal use of its owner and properly protected in order to insure the privacy of any information it contains. However, at the user's option, whole or part of this information can be shared on a peer-to-peer network, in an anonymous or certified way, to become part of a distributed knowledge base that all clients connected to the network will be able to use in order to enhance their own performance when locating data sources or grabbing data with pre-generated scrapers. Ultra peers with large bandwidth and high availability will be the preferred hosts on the network for pieces of data that serve as reference for the whole community or for a sub-community of experts in a specific field. The most frequently used Data Objects will be shared on the most visible and available ultra peers, in particular on the servers of the makers of the present invention. This distributed indexing of the Web and less widely accessible resources allows each connected member of the peer-to-peer network, before calling CPU intensive and time consuming tasks of recognizing data structure or locating a data source, to launch a query on the peer-to-peer network which will be semantically routed to the most pertinent experts currently connected and see if recent data, data sources, meta-data, or data scraping tools are not available to speed-up the process or enhance the quality of the results.

What is claimed is:

1. A data collection system requiring no preliminary set-up and scripting tasks, characterized by the combination of:
a one-click automation module, to browse through the sources,
one-click filters to view directly the type of data they are looking for within the pages,
an non-volatile, multi-purpose repository to collect and prioritize the data they find while surfing, whatever its structure is,
an automatic system to check on the users own machine and amongst their peers if a similar query was not performed recently, in order to reuse successful extraction processes or results themselves, if they haven't changed, and
an easy way to structure and export their collections for other applications.

2. A system as set forth in claim 1, for collecting data from electronic documents by recognizing the structure of data as well as a plurality of data element types characterized by a combination of functionalities including a one-click automation system to navigate through the electronic documents, a query system to locate data through other systems on the network which may have already performed similar searches, filtered views of the electronic documents or pages, an automatic structure recognition system and a multi-purpose collection basket, which is a user database accepting polymorphic data, the collected data being stored into an user's basket, as the user or the program navigates from document to document or page to page, these associated documents being automatically downloaded by the system and saved to storage devices when the collected data includes links to other documents.

3. A system as set forth in claim 1, comprising an object maker module which allows to create and edit information objects destined to be stored in the web memory of the system and possibly shared on the Web or on a peer-to-peer network, the system providing the user with a toolbox to create a new class (or subclass inheriting properties of a parent class) describing it and modifying it, the system excluding the possibility of creating duplicate classes within the accessible area (the local system, resources of a centralized server and/or the peers of the network, if the system is connected to one).

4. A structure recognition process characterized by 5 main steps:
constitution of a work dictionary of marker candidates for different types of markers (label markers, labels, field delimiters, record delimiters, list markers, etc.) using all available tags (XML, HTML . . . ), punctuation or layout description strings, an original dictionary of pre-set marker candidates being augmented of strings recurring frequently in the document as well as of characters or strings consistently located, in the current document, between easily recognizable patterns like phone numbers or email addresses;
combination of the markers of the dictionary in order to generate regular expression patterns and the number of occurrences of each pattern is added to arrays on which are then performed a series of statistical computations to extract possible numbers of records in the document and reliability marks are given to the different solutions;
selecting of the result of this analysis is a series of regular expressions (or masks) as the best way to scrape the data in the document. This automatically generated set of scraping patterns is saved for future use (by the user or an other peer on the network, which could have the same need for scraping this source) and associated to the URL of the current HTML page or document;
extraction of data from the current page by applying the generated scraper, and is presented in a table where the recognized records are displayed as rows, the fields as the columns and the labels if present are used as column headings. Applying the scraper consists of parsing the document record by record and field by field (or item by item, in the case of a single column list), using the delimiters and masks of the scraper. If several fields of the same record have the same label, they will be presented in two columns with the same heading (possibly suffixed with an incremented index); and
post processing of the whole table once all the data is placed in rows and columns, cell by cell, to clean the text of possible noise, de-duplicate redundant data, arrange the layout, optimize column sizes, etc.
